(19) United States
(12) Patent Application Publication
(10) Pub. No.: US 2016/0283786 A1
(43) Pub. Date: Sep. 29, 2016

(54) IMAGE PROCESSOR, IMAGE PROCESSING METHOD, AND NON-TRANSITORY RECORDING MEDIUM

(71) Applicant: Kabushiki Kaisha Toshiba, Tokyo (JP)

(72) Inventor: Kazunori Imoto, Kawasaki Kanagawa (JP)

(21) Appl. No.: 15/066,629

(22) Filed: Mar. 10, 2016

(30) Foreign Application Priority Data
Mar. 23, 2015 (JP) 2015-060058

(51) Int. Cl. G06K 9/00; G06K 9/34

(52) U.S. Cl. CPC G06K 9/00409; G06K 9/00852; G06K 9/344; G06K 2209/011

(57) ABSTRACT

According to one embodiment, an image processor includes an acquisitor and a processor. The acquisitor acquires an input image including a first character string. The processor implements a first operation of generating a first generated image from a first extracted image based on an arranged state of the first character string. The first extracted image is extracted from the input image. The first extracted image is relating to the first character string. The first extracted image extends in a first direction. The first generated image extends in a second direction different from the first direction.

### CROSS-REFERENCE TO RELATED APPLICATIONS

This application is based upon and claims the benefit of priority from Japanese Patent Application No. 2015-060058, filed on Mar. 23, 2015; the entire contents of which are incorporated herein by reference.

### FIELD

Embodiments described herein relate generally to an image processor, an image processing method and a non-transitory recording medium.

### BACKGROUND

In an image processor that processes handwritten characters, it is desirable to arrange the handwritten characters for easy viewing.

### BRIEF DESCRIPTION OF THE DRAWINGS

FIG. 1 is a block diagram showing an image processor according to a first embodiment;

FIG. 2A and FIG. 2B are schematic views showing an input image according to the first embodiment;

FIG. 3 is a schematic view showing the image processing method according to the first embodiment;

FIG. 4 is a schematic view showing the image processing method according to the first embodiment;

FIG. 5 is a schematic view showing the image processing method according to the first embodiment;

FIG. 6 is a schematic view showing the image processing method according to the first embodiment;

FIG. 7A and FIG. 7B are schematic views showing the image processing method according to the first embodiment;

FIG. 8 is a schematic view showing the image processing method according to the first embodiment;

FIG. 9A and FIG. 9B are schematic views showing the image processing method according to the first embodiment;

FIG. 10 is a schematic view showing the image processing method according to the first embodiment;

FIG. 11 is a flowchart showing the image processing method according to the first embodiment;

FIG. 12 is a flowchart showing the image processing method according to the first embodiment;

FIG. 13 is a schematic view showing an input image according to the second embodiment;

FIG. 14 is a schematic view showing an image processing method according to the second embodiment;

FIG. 15 is a schematic view showing an image processing method according to the second embodiment;

FIG. 16 is a schematic view showing an image processing method according to the second embodiment;

FIG. 17 is a schematic view showing the input image according to the third embodiment;

FIG. 18 is a schematic view showing the input image according to the third embodiment;

FIG. 19 is a block diagram showing an image processor according to a fourth embodiment;

FIG. 20 is a schematic view showing the input image according to the fourth embodiment;

FIG. 21 is a schematic view showing the image processing method according to the fourth embodiment;

FIG. 22 is a schematic view showing the image processing method according to the fourth embodiment;

FIG. 23 is a block diagram showing an image processor according to a fifth embodiment;

FIG. 24 is a schematic view showing an input image according to the fifth embodiment;

FIG. 25 is a schematic view showing an image processing method according to the fifth embodiment;

FIG. 26 is a schematic view showing an image processing method according to the fifth embodiment;

FIG. 27 is a schematic view showing an image processing method according to the fifth embodiment;

FIG. 28 is a schematic view showing an image processing method according to the fifth embodiment;

FIG. 29 is a schematic view showing an input image according to a sixth embodiment;

FIG. 30 is a schematic view showing an input image according to a sixth embodiment;

FIG. 31A, FIG. 31B, FIG. 31C, and FIG. 31D are schematic views showing arrangement patterns according to a seventh embodiment; and

FIG. 32 is a block diagram showing an image processor according to an eighth embodiment.

### DETAILED DESCRIPTION

According to one embodiment, an image processor includes an acquisitor and a processor. The acquisitor acquires an input image including a first character string. The processor implements a first operation of generating a first generated image from a first extracted image based on an arranged state of the first character string. The first extracted image is extracted from the input image. The first extracted image is relating to the first character string. The first extracted image extends in a first direction. The first generated image extends in a second direction different from the first direction.

According to another embodiment, an image processing method includes acquiring an input image including a first character string. The method includes generating a first generated image from a first extracted image based on an arranged state of the first character string. The first extracted image is extracted from the input image. The first extracted image is relating to the first character string. The first extracted image extends in a first direction. The first generated image extends in a second direction different from the first direction.

According to another embodiment, a non-transitory recording medium has an image processing program being recorded in the recording medium. The program causes a computer to execute acquiring an input image including a first character string. The program causes the computer to execute generating a first generated image from a first extracted image based on an arranged state of the first character string. The first extracted image is extracted from the input image. The first extracted image is relating to the first character string. The first extracted image extends in a first direction. The first generated image extends in a second direction different from the first direction.

Various embodiments of the invention will be described hereinafter with reference to the accompanying drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

25

### First Embodiment

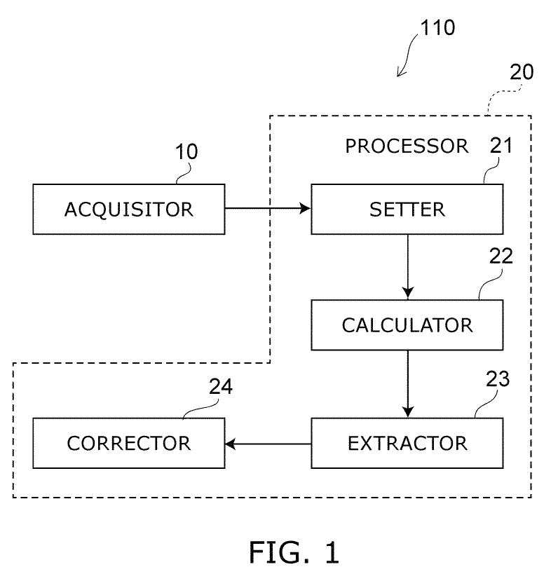

FIG. 1 is a block diagram showing an image processor according to a first embodiment.

The image processor 110 of the embodiment includes an acquisitor 10 and a processor 20. The acquisitor 10 includes, for example, input/output terminals. The acquisitor 10 includes an input/output interface that communicates with the outside via a wired or wireless method. The processor 20 includes, for example, a calculating device including a CPU (Central Processing Unit), memory, etc. A portion of each block or each entire block of the processor 20 may include an integrated circuit such as LSI (Large Scale Integration), etc., or an IC (Integrated Circuit) chipset. Each block may include an individual circuit; or a circuit in which some or all of the blocks are integrated may be used. The blocks may be provided as one body; or some blocks may be provided separately. Also, for each block, a portion of the block may be provided separately. The integration is not limited to LSI; and a dedicated circuit or a general-purpose processor may be used.

A setter 21, a calculator 22, an extractor 23, and a corrector 24 are provided in the processor 20. For example, these components are realized as an image processing program. In other words, the image processor 110 also may be realized by using a general-purpose computer device as the basic hardware. The functions of each component included in the image processor 110 may be realized by causing a processor mounted in the computer device recited above to execute the image processing program. In such a case, the image processor 110 may be realized by preinstalling the image processing program recited above in the computer device; or the image processor 110 may be realized by storing the image processing program recited above in a storage medium such as CD-ROM, etc., or distributing the image processing program via a network and appropriately installing the image processing program in the computer device. The processor 20 also may be realized by appropriately utilizing a storage medium such as memory, a hard disk, CD-R, CD-RW, DVD-RAM, DVD-R, etc., connected externally or built into the computer device recited above.

For example, the image processor 110 according to the embodiment is applied to application software for arranging an image in which a handwritten character string written on a whiteboard, a blackboard, a notebook, etc., is imaged so that the image is easy to view. For example, such application software is used for a handwritten character string in which the tilt, the character spacing, and the character size fluctuate easily between the characters. An image in which a handwritten character string is imaged by a camera is modified for easy viewing by modifying the size, arrangement, etc., of the handwritten characters included in the handwritten character string.

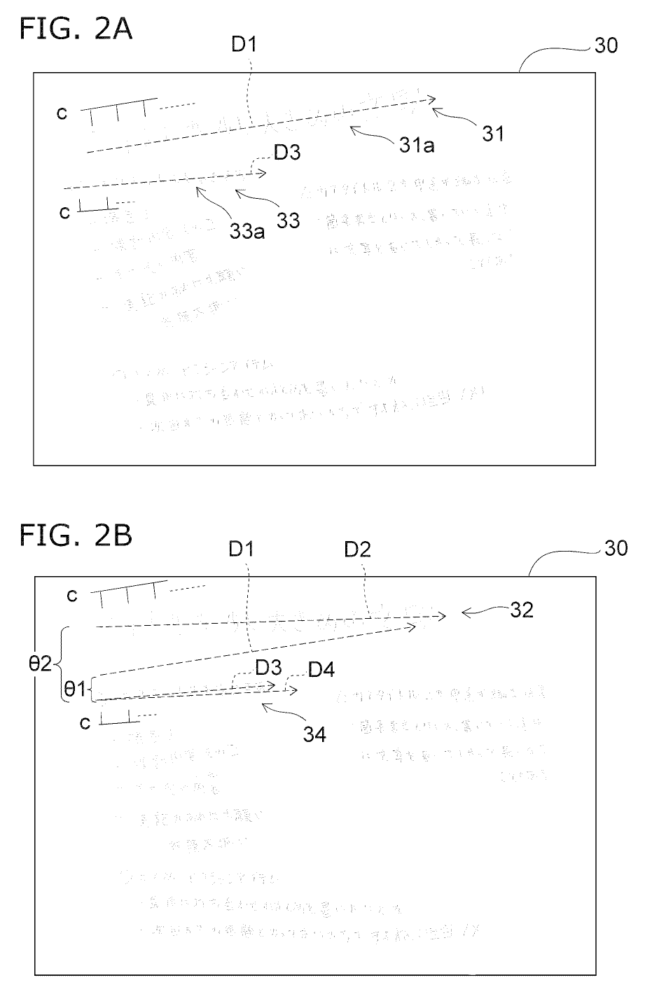

FIG. 2A and FIG. 2B are schematic views showing an input image according to the first embodiment.

FIG. 2A shows the state of the input image prior to the tilt modification.

FIG. 2B shows the state of the input image after the tilt modification.

The acquisitor 10 acquires the input image 30. The input image 30 is, for example, an image formed by imaging multiple handwritten characters written on a whiteboard, a blackboard, etc., by a lecturer performing a lecture, a chairperson chairing a meeting, etc. The acquisitor 10 may acquire the input image 30 from an imaging device such as a digital still camera, etc. The acquisitor 10 may acquire the input image 30 from a storage medium such as a HDD (Hard Disk Drive), etc.

The input image 30 includes a first extracted image 31 relating to a first character string 31a. The first character string 31a includes multiple handwritten characters c. In the embodiment, handwritten characters such as kanji, hiragana, and katakana of Japanese, etc., are used as the multiple characters c. Handwritten numerals, various symbols, figures, etc., also are used as the multiple characters c.

The processor 20 extracts the first extracted image 31 from the input image 30. The first extracted image 31 extends in a first direction D1 relating to the first character string 31a. The processor 20 implements a first operation of generating, from the first extracted image 31 based on the state of the first character string 31a, a first generated image 32 extending in a second direction D2 that is different from the first direction D1. For example, the first character string 31a is tilted with respect to the row direction (the horizontal direction of the input image 30). The tilt with respect to the row direction of the second direction D2 is smaller than the tilt with respect to the row direction of the first direction D1. The first extracted image 31 is shown in FIG. 2A; and the first generated image 32 is shown in FIG. 2B. In other words, the tilt of the first character string 31a is modified.

The input image 30 further includes a second extracted image 33 relating to a second character string 33a. The second character string 33a includes multiple handwritten characters c.

The processor 20 extracts the second extracted image 33 from the input image 30. The second extracted image 33 extends in a third direction D3 relating to the second character string 33a. As shown in FIG. 2A and FIG. 2B, an absolute value θ1 of the angle between the first direction D1 and the third direction D3 is larger than an absolute value θ2 of the angle between the second direction D2 and the third direction D3. The tilt of the first direction D1 with respect to the third direction D3 is larger than the tilt of the second direction D2 with respect to the third direction D3.

The processor 20 generates, from the second extracted image 33 based on the state of the second character string 33a, a second generated image 34 extending in a fourth direction D4 that is different from the third direction D3. For example, the second character string 33a is tilted with respect to the row direction. The tilt of the fourth direction D4 with respect to the row direction is smaller than the tilt of the third direction D3 with respect to the row direction. The fourth direction D4 may be the same as the second direction D2. The second extracted image 33 is shown in FIG. 2A; and the second generated image 34 is shown in FIG. 2B. In other words, the tilt of the second character string 33a is modified.

The tilt of the first character string 31a with respect to the row direction is larger than the tilt of the second character string 33a with respect to the row direction. Therefore, the modification amount of the tilt of the first character string 31a is larger than the modification amount of the tilt of the second character string 33a. Thereby, the tilts of the first extracted image 31 and the second extracted image 33 are modified. The first generated image 32 and the second generated image 34 after the tilt modification are arranged to be substantially horizontal in the input image 30. Similarly, the tilt can be modified for other images relating to character strings as well.

Here, there is a reference example in which character recognition is performed for multiple handwritten characters written in a predetermined designated frame as one character string; and the tilt of the character string, etc., are modified after the character recognition. In such a reference example, there are cases where a whiteboard, a blackboard, etc., on which handwritten character strings having different causes of fluctuation are multiply mixed cannot be accommodated.

In the embodiment, the tilt of the handwritten character string can be modified for each handwritten character string. Therefore, even for the image in which the handwritten character strings are multiply mixed, the handwritten characters can be arranged for easier viewing as handwritten characters.

For example, in a meeting, it is often that a participant handwrites a meeting memo on a whiteboard, etc. It is considered that the handwritten meeting memo is associated with the content of the meeting and remains in the memory of the participant. Therefore, by keeping the image of the meeting memo as a handwritten meeting memo that has an arrangement that is easier to view, the participant that views the image can intuitively recall the content of the meeting. It is difficult to obtain such an effect when the handwritten meeting memo is converted into digital character data by the character recognition of such a reference example. According to the embodiment, the handwritten characters can be modified to an arrangement that is easier to view as handwritten characters. Therefore, the ease of viewing can be improved while keeping the merits of being handwritten.

A specific image processing method using the image processor 110 will now be described.

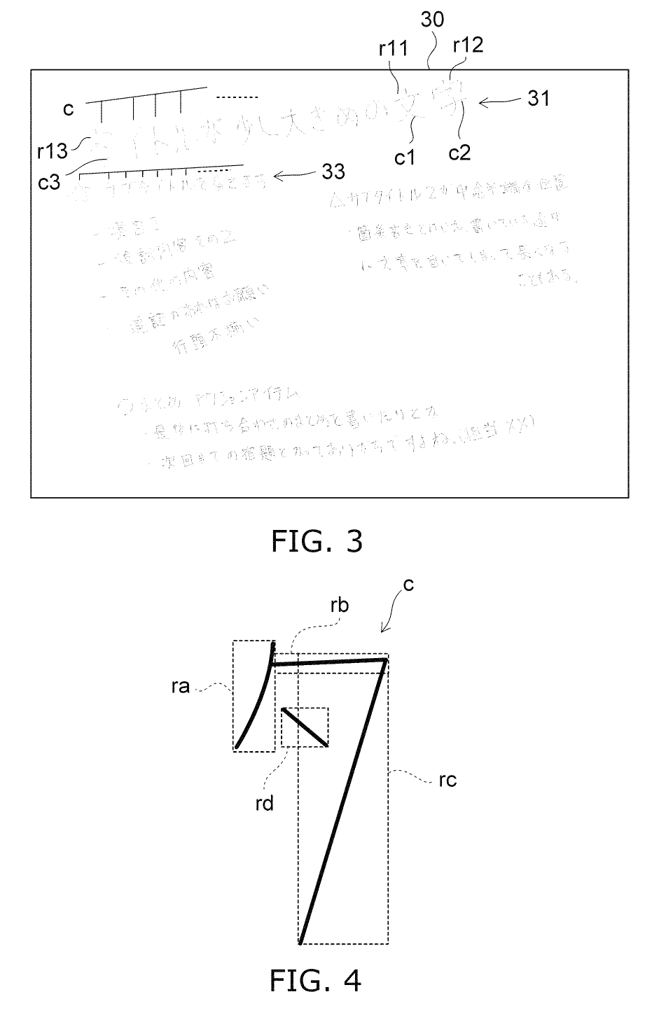

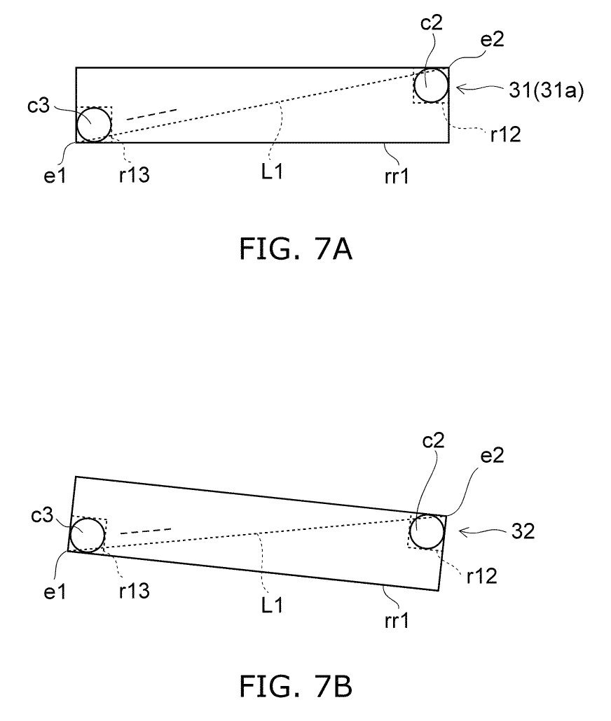

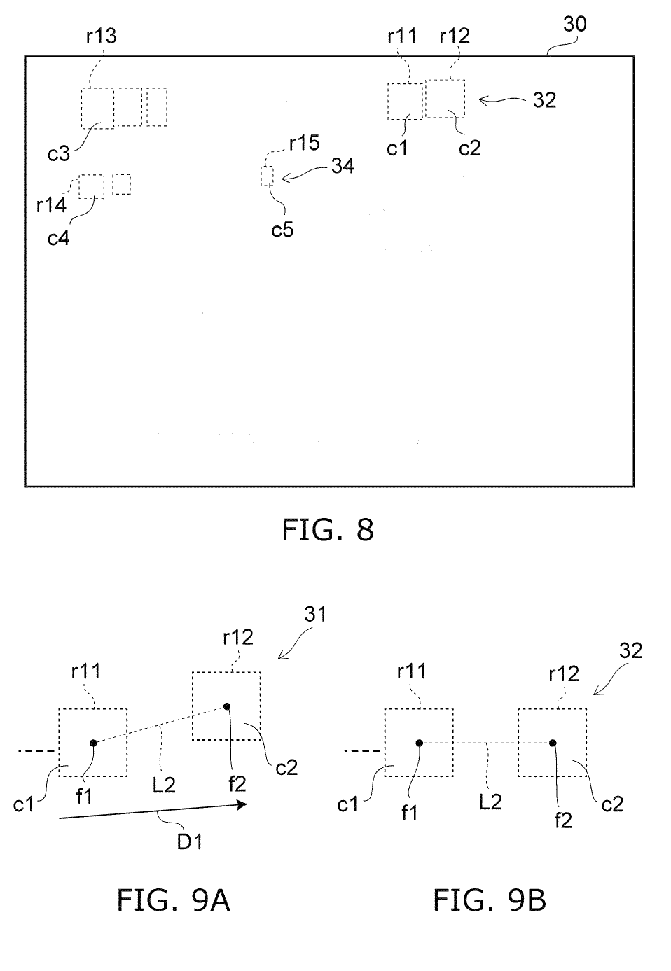

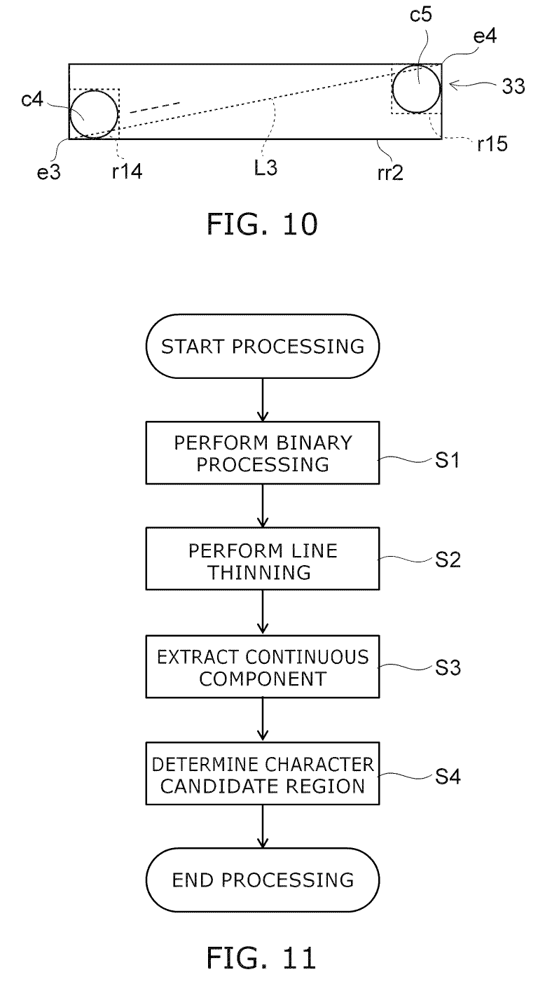

FIG. 3 to FIG. 6, FIG. 7A, FIG. 7B, FIG. 8, FIG. 9A, FIG. 9B, and FIG. 10 are schematic views showing the image processing method according to the first embodiment.

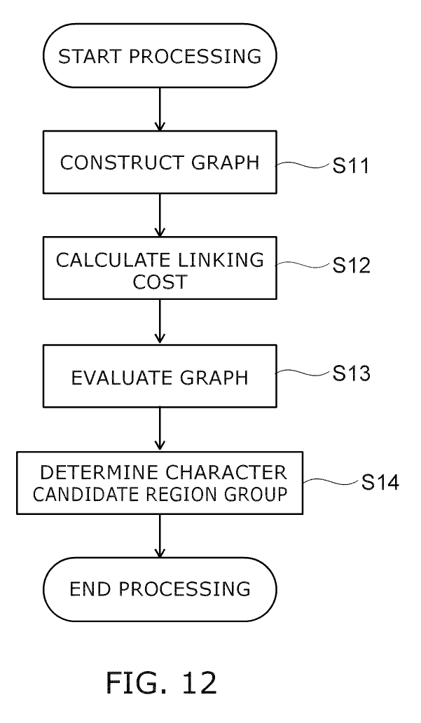

FIG. 11 and FIG. 12 are flowcharts showing the image processing method according to the first embodiment.

FIG. 3 shows a setting result by the setter 21.

FIG. 4 is an enlarged drawing of a character c.

The setter 21 implements setting processing. In the setting processing as shown in FIG. 3, multiple regions r (hereinbelow, called the character candidate regions r) are set for the input image 30. Each of the multiple character candidate regions r includes at least a portion of one character c included in the input image 30. The character candidate region r is a set of pixels included in the at least a portion of the one character c. The character candidate region r is, for example, a region around the one character c. In the case where the one character c is kanji or the like, the character candidate region r may be a region including a portion such as a left-side radical, a right-side radical, or the like of the kanji. The image relating to the character string can be extracted from the input image 30 by setting the character candidate regions r. The multiple character candidate regions r includes a first character candidate region r11, a second character candidate region r12, and a third character candidate region r13. The first character candidate region r11 includes at least a portion of a first character c1. The second character candidate region r12 includes at least a portion of a second character c2. The third character candidate region r13 includes at least a portion of a third character c3.

Most simply, it may be considered to use one connected component included in the character c as one character candidate region r. As shown in FIG. 4, the case is assumed where one character c has four connected components. In such a case, the character c includes four character candidate regions ra to rd. The four character candidate regions ra to rd can be collected into one character candidate region r For example, a reference size is set; and the multiple character candidate regions contained within the range of the reference size are used as one character candidate region. Thereby, one character candidate region r can correspond to one character c.

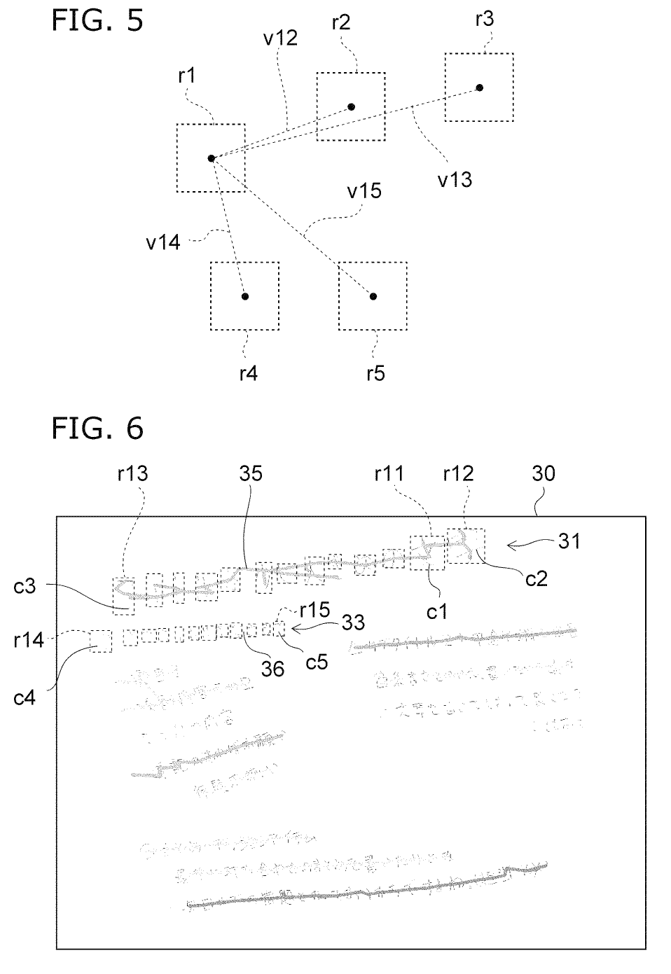

FIG. 5 is a schematic view showing calculation processing performed by the calculator 22.

FIG. 6 is a schematic view showing an extraction result extracted by the extractor 23.

The calculator 22 implements the calculation processing. In the calculation processing, one of the multiple character candidate regions r is set as a reference region; and evaluation values relating to the ease of forming links between the reference region and each of the multiple character candidate regions r other than the reference region are calculated.

As shown in FIG. 5, among multiple character candidate regions r1 to r5, for example, the character candidate region r1 is set as the reference region (hereinbelow, the reference region r1). An evaluation value v12 between the reference region r1 and the character candidate region r2 is calculated. Here, for example, the linking cost (described below) for determining whether or not two character candidate regions are easy to link to each other may be used as the evaluation value. For example, it may be determined that it is easier to form a link as the evaluation value decreases.

Similarly, an evaluation value v13 between the reference region r1 and the character candidate region r3 is calculated. An evaluation value v14 between the reference region r1 and the character candidate region r4 is calculated. An evaluation value v15 between the reference region r1 and the character candidate region r5 is calculated. Thus, it is sufficient to calculate an evaluation value for each combinable pair of character candidate regions in the input image 30.

The extractor 23 implements extraction processing. In the extraction processing as shown in FIG. 6, the first extracted image 31 that includes the multiple character candidate regions r is extracted from the input image 30 based on the evaluation values recited above. The first extracted image 31 is extracted as the set of the multiple character candidate regions r connected by a line 35. The first character candidate region r11, the second character candidate region r12, and the third character candidate region r13 are included in the set connected by the line 35. The third character candidate region r13 includes the third character c3 positioned at one end of the first extracted image 31. The second character candidate region r12 includes the second character c2 positioned at the other end of the first extracted image 31. The first character candidate region r11 includes the first character c1 positioned to be adjacent to the second character c2.

Similarly, the extractor 23 extracts the second extracted image 33 including the multiple character candidate regions r from the input image 30 based on the evaluation values recited above. The second extracted image 33 is extracted as the set of the multiple character candidate regions r connected by a line 36. A fourth character candidate region r14 and a fifth character candidate region r15 are included in the set connected by the line 36. The fourth character candidate region r14 includes a fourth character c4 positioned at one end of the second extracted image 33. The fifth character candidate region r15 includes a fifth character c5 positioned at the other end of the second extracted image 33. Thus, the extractor 23 extracts the set of the character candidate regions r for each of the multiple images included in the input image 30.

FIG. 7A and FIG. 7B are schematic views showing modification processing by the corrector 24.

FIG. 7A shows the first extracted image 31 prior to the tilt modification.

FIG. 7B shows the first generated image 32 after the tilt modification.

FIG. 8 is a schematic view showing the input image after the tilt modification.

The corrector 24 implements the modification processing. As shown in FIG. 7A, the setter 21 sets a first rectangular region rr1 around the first extracted image 31. The first rectangular region rr1 includes a first edge e1 that contacts the third character candidate region r13 (the third character c3), and a second edge e2 that contacts the second character candidate region r12 (the second character c2). The second edge e2 is positioned at a corner opposite the first edge e1. In the modification processing, a first tilt of a line segment L1 connecting the first edge e1 and the second edge e2 is modified. The first tilt is a tilt with respect to the set direction determined inside the input image 30. The first tilt is, for example, a tilt with respect to the row direction (the horizontal direction) of the input image 30. Thereby, the first generated image 32 is generated from the first extracted image 31.

FIG. 7A shows the first tilt of the line segment L1 prior to the tilt modification; and FIG. 7B shows the first tilt of the line segment L1 after the tilt modification. It can be seen that the first tilt of the line segment L1 after the tilt modification is small compared to the first tilt of the line segment L1 prior to the tilt modification. The first extracted image 31 of FIG. 7A is modified to the first generated image 32 of FIG. 7B. In other words, from the perspective of easy viewing, it is favorable for the first tilt of the line segment L1 to be small. By reducing the first tilt of the line segment L1, the first character string 31a relating to the first extracted image 31 can be arranged in an easily-viewable state in which the tilt is suppressed.

Here, it is possible to adjust how much the modification is performed by, for example, using the settings of a user, etc. For example, the setting may be in a range of 0 to 100%, where 0% is the state in which the first tilt of the line segment L1 is not modified, and 100% is the state in which the first tilt of the line segment L1 is modified to be zero (horizontal). In such a case, it is favorable for the image processor 110 to include a display unit. The display unit displays a setting screen to receive the settings set by the user.

Thus, the first generated image 32 of FIG. 8 is generated from the first extracted image 31 of FIG. 6. A similar modification is possible for the tilt of the second extracted image 33 as well. In other words, the second generated image 34 of FIG. 8 is generated from the second extracted image 33 of FIG. 6. A similar modification is possible for the tilts of images other than the first extracted image 31 and the second extracted image 33.

In the embodiment, the tilt of the handwritten character string can be modified for each handwritten character string. Therefore, even for the image in which the handwritten character strings are multiply mixed, the handwritten characters can be arranged for easier viewing as handwritten characters.

FIG. 9A and FIG. 9B are schematic views showing another modification processing performed by the corrector 24.

FIG. 9A shows a portion of the first extracted image 31 prior to the tilt modification.

FIG. 9B shows a portion of the first generated image 32 after the tilt modification.

In the example of FIG. 9A, a line segment L2 that connects a center f1 of the first character candidate region r11 and a center f2 of the second character candidate region r12 is tilted with respect to the first direction D1. In the modification processing of the example, a second tilt of the line segment L2 is modified between the first character candidate region r11 (the first character c1) and the second character candidate region r12 (the second character c2) (a second operation). It is sufficient for the line segment L2 to be a line segment connecting the first character c1 and the second character c2. The line segment L2 may not be a line segment connecting the centers. The tilt between two character candidate regions adjacent to each other in the first extracted image 31 is modified. FIG. 9A shows the second tilt of the line segment L2 prior to the tilt modification; and FIG. 9B shows the second tilt of the line segment L2 after the tilt modification. It can be seen that the second tilt of the line segment L2 after the tilt modification is small compared to the second tilt of the line segment L2 prior to the tilt modification. A similar modification is possible for other mutually-adjacent character candidate regions in the first extracted image 31 as well. Thus, the tilt between two mutually-adjacent characters may be reduced.

By modifying the second tilt of the line segment L2, the positional relationship between the first character candidate region r11 and the second character candidate region r12 is changed. In other words, the positional relationship between the first character c1 and the second character c2 is changed. Specifically, from the perspective of easy viewing, it is favorable for the second tilt of the line segment L2 to be small. By reducing the second tilt of the line segment L2, two mutually-adjacent handwritten characters can be arranged in an easily-viewable state in which the tilt is suppressed.

It is possible to adjust how much the modification is performed by the settings of the user, etc. For example, the setting may be in a range of 0 to 100%, where 0% is the state in which the second tilt of the line segment L2 is not modified, and 100% is the state in which the second tilt of the line segment L2 is modified to a direction parallel to the first direction D1.

Thereby, the two characters of the first extracted image 31 are arranged for easy viewing as handwritten characters. A similar tilt modification is possible for two characters of the second extracted image 33 as well. A similar tilt modification is possible for two characters of images other than the first extracted image 31 and the second extracted image 33 as well.

FIG. 10 is a schematic view showing other modification processing performed by the corrector 24.

The corrector 24 may modify the first tilt of the line segment L1 of the input image 30 when the first tilt of the line segment L1 of the first rectangular region rr1 is larger than a first reference tilt. In other words, it is determined whether or not the first tilt of the line segment L1 is larger than the first reference tilt; and the first tilt of the line segment L1 is modified based on the determination result. For example, when the first tilt of the line segment L1 is larger than the first reference tilt, the first tilt of the line segment L1 is modified to be the first reference tilt. On the other hand, when the first tilt of the line segment L1 is smaller than the first reference tilt, the first tilt of the line segment L1 is not modified.

The average value of the first tilt of the first extracted image 31 and a third tilt of the second extracted image 33 may be used as the first reference tilt. As shown in FIG. 7A, the corrector 24 sets the first rectangular region rr1 around the first extracted image 31. The first rectangular region rr1 includes the first edge e1 that contacts the third character candidate region r13 (the third character c3), and the second edge e2 that contacts the second character candidate region r12 (the second character c2). The second edge e2 is positioned at a corner opposite the first edge e1. The corrector 24 determines the first tilt of the line segment L1 connecting the first edge e1 and the second edge e2.

As shown in FIG. 10, the corrector 24 sets a second rectangular region rr2 around the second extracted image 33. The second rectangular region rr2 includes a third edge e3 that contacts the fourth character candidate region r14 (the fourth character c4), and a fourth edge e4 that contacts the fifth character candidate region r15 (the fifth character c5). The fourth edge e4 is positioned at a corner opposite the third edge e3. The corrector 24 determines the third tilt of a line segment L3 connecting the third edge e3 and the fourth edge e4. Thus, the average value of the first tilt of the first extracted image 31 and the third tilt of the second extracted image 33 is determined as the reference tilt.

The average value of the tilts of the images relating to all of the character strings included in the input image 30 may be used as the first reference tilt. Zero (horizontal) which is the state of no tilt may be used as the first reference tilt.

In the description recited above, the modification of the first tilt of the line segment L1 may be large when the difference between the first reference tilt and the first tilt of the line segment L1 is large; and the modification of the first tilt of the line segment L1 may be small when the difference between the first reference tilt and the first tilt of the line segment L1 is small. The first tilt of the line segment L1 may be modified so that the difference between the first reference tilt and the first tilt of the line segment L1 is zero. Thus, the modification may be performed so that the overall tilt of the first extracted image 31 approaches the first reference tilt.

Here, in FIG. 9A and FIG. 9B, the corrector 24 may modify the second tilt of the line segment L2 when the second tilt with respect to the first direction D1 of the line segment L2 connecting the center f1 of the first character candidate region r11 (the first character c1) to the center f2 of the second character candidate region r12 (the second character c2) is larger than a second reference tilt. For example, the average value of the tilts between mutually-adjacent character candidate regions of the first extracted image 31 may be used as the second reference tilt. The second reference tilt is not limited thereto.

FIG. 11 is a flowchart showing the setting processing performed by the setter 21.

FIG. 3 shows the result of setting the multiple character candidate regions r from the input image 30.

As shown in FIG. 11, the method for setting the character candidate regions by the setter 21 includes binary processing (step S1), line thinning processing (step S2), connected component extraction processing (step S3), and character candidate region determination processing (step S4).

In the binary processing of step S1, the background pixels and the writing pixels are separated from each other. The writing pixels are the pixels corresponding to the handwritten character portions. Specifically, for example, a method such as discriminant analysis or the like is used. In discriminant analysis, the input image 30 is converted to grayscale; a histogram of the pixel values is calculated for each local region; and the boundary that separates the background pixels and the writing pixels is determined adaptively. Sufficient separation performance can be ensured by this method in the case where the contrast between the background pixels and the writing pixels is sufficient in the image in which the whiteboard, the blackboard, or the like is imaged.

In the line thinning of step S2, the pixels of the core line (the core line pixels) which are at the center of the stroke and the pixels at the periphery of the core line are separated for the writing pixels separated by the binary processing; and only the core line pixels are extracted. Specifically, a 3×3 image filter is applied; and in the case where adjacent writing pixels exist, only the core line pixels are selected by passing through the image filter.

In the connected component extraction processing of step S3, attributes such as an isolated point, an intersection, a normal point, etc., are attributed based on the adjacent relationships of the core line pixels. Based on the attributes, the set of the writing pixels adjacent to the core line pixels is extracted as one connected component.

In the character candidate region determination processing of step S4, the character candidate region r is determined based on the result of the connected components. Most simply, the method of using one connected component as the character candidate region r may be used. The result of the character candidate regions r being set by the setter 21 is shown in FIG. 3. The frames of the dotted lines of FIG. 4 correspond to the character candidate regions r that are set. Here, to accommodate cases such as Japanese where fragments (the left-side radical, the right-side radical, etc.) of kanji, etc., are independent connected components, it is favorable to determine a reference size and use the connected components contained in the range of the reference size as one character candidate region r.

FIG. 12 is a flowchart showing the extraction processing performed by the extractor 23.

The extraction results of the first extracted image 31 and the second extracted image 33 are shown in FIG. 6.

As shown in FIG. 12, the method for extracting the set of the character candidate regions for each character string by the extractor 23 includes graph construction processing (step S11), linking cost calculation processing (step S12), graph evaluation processing (step S13), and character candidate region group determination processing (step S14).

In the graph construction processing of step S11, the character candidate regions r that are set in the setter 21 are used as basic units (nodes). The graph is constructed by connecting spatially-proximal character candidate regions with arcs.

In the linking cost calculation processing of step S12, the linking cost for determining whether or not the character candidate regions are easy to link to each other is defined for the arcs. For the linking cost, for example, the similarity of the size, the distance between the character candidate regions, etc., may be used as the reference.

In the graph evaluation of step S13, it is determined which combination of character candidate regions r has a small linking cost when subdividing a portion of the graph for the graphs that are constructed.

In the character candidate region group determination processing of step S14, it is determined that the combination of character candidate regions r determined by the graph evaluation recited above is a group of the same character string (the set of the character candidate regions).

In FIG. 6, the multiple character candidate regions r that are extracted as the same handwritten character string are displayed as being connected by the same line (the line 35 or the line 36). Here, one embodiment is shown in which the set of the character candidate regions is extracted for each handwritten character string. The embodiment is not limited thereto.

Thus, according to the embodiment, the overall tilt or the partial tilt of the handwritten character string can be modified for each handwritten character string. Therefore, the handwritten characters can be arranged for easier viewing as handwritten characters even for the image in which the handwritten character strings are multiply mixed.

### Second Embodiment

In the embodiment, the spacing between two mutually-adjacent characters is modified for each handwritten character string. In other words, processing of modifying the spacing between two characters c is implemented (a third operation) when the spacing between the two characters c is larger than a reference spacing.

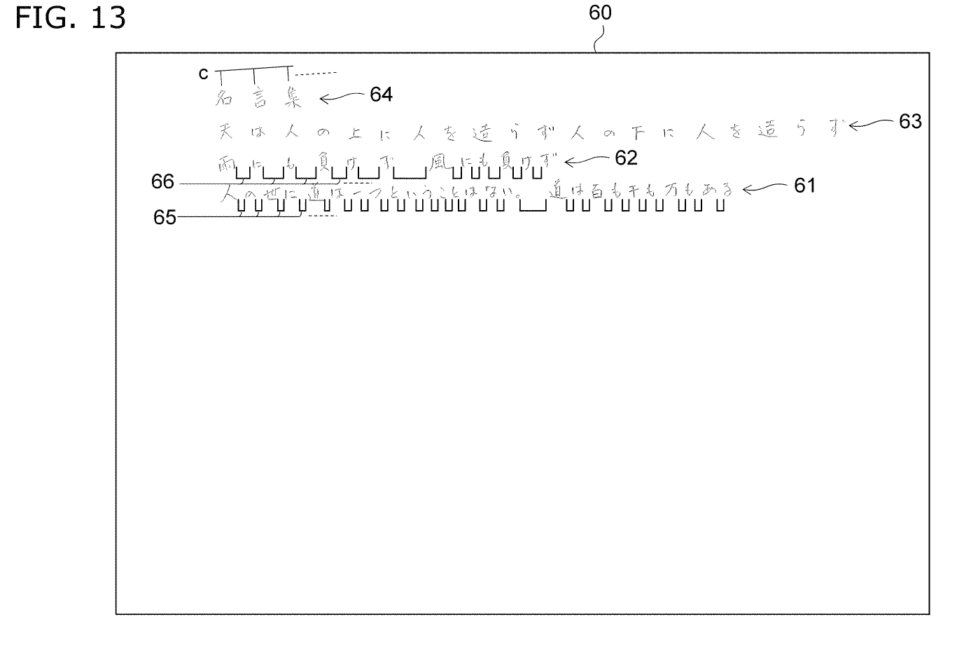

FIG. 13 is a schematic view showing an input image according to the second embodiment.

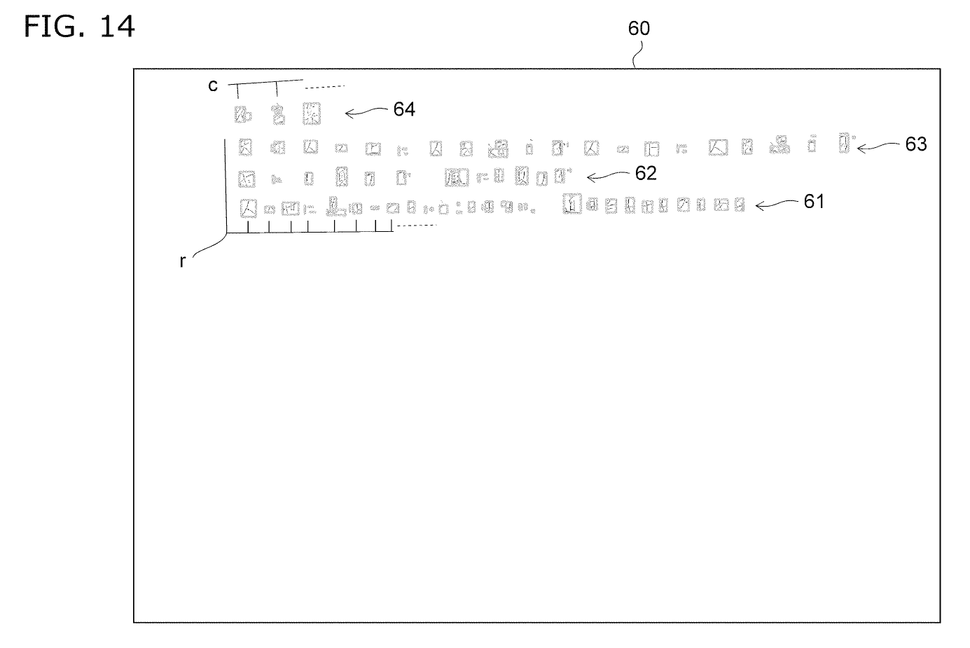

FIG. 14 to FIG. 16 are schematic views showing an image processing method according to the second embodiment.

FIG. 14 is a schematic view showing the setting results set by the setter 21.

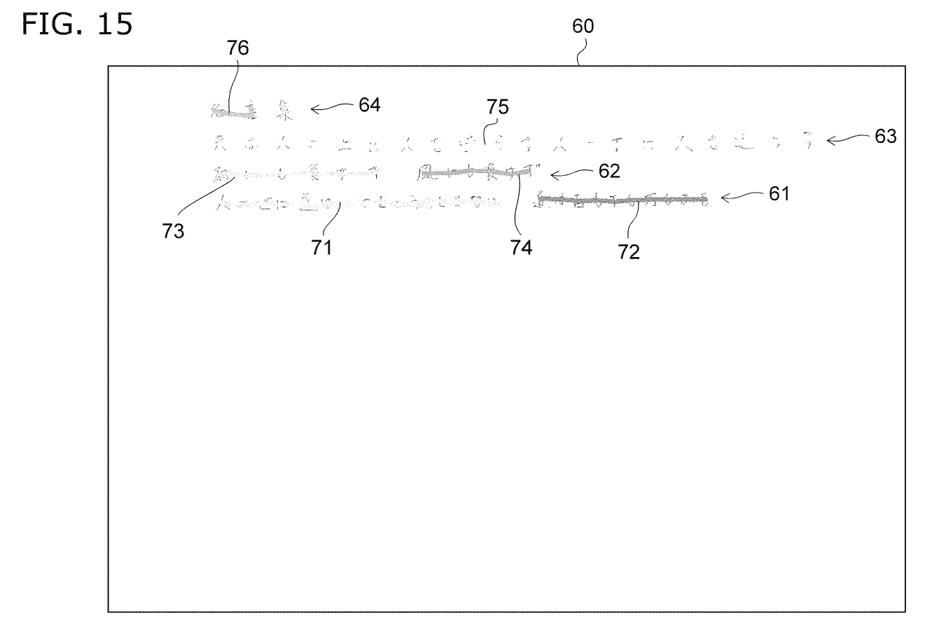

FIG. 15 is a schematic view showing an extraction result extracted by the extractor 23.

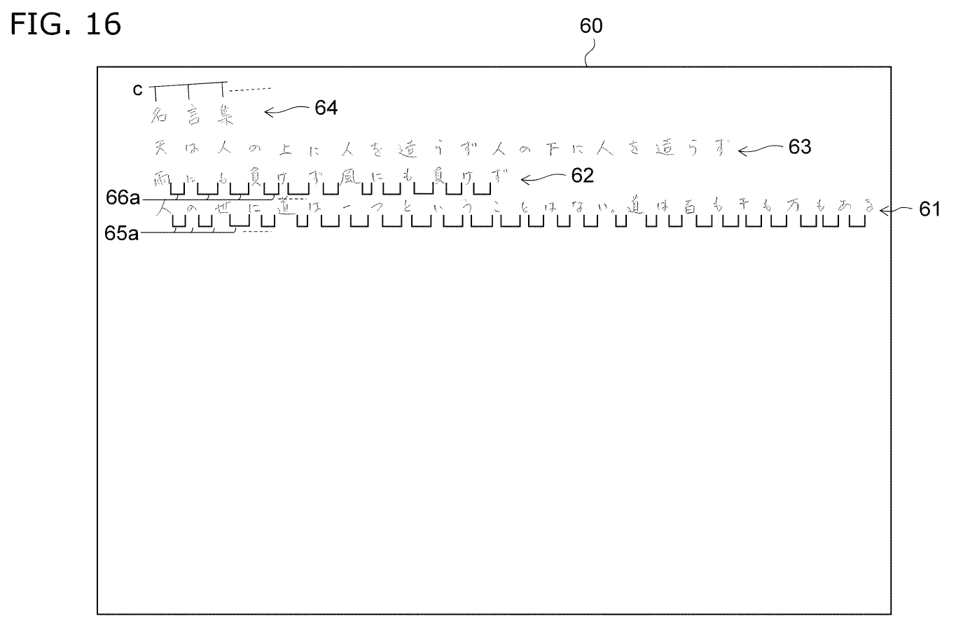

FIG. 16 is a schematic view showing the input image after the character spacing modification.

The acquisitor 10 acquires the input image 60 as shown in FIG. 13. The input image 60 includes the first to fourth character strings 61 to 64. Each of the first to fourth character strings 61 to 64 includes multiple handwritten characters c. In the example, the spacing between mutually-adjacent characters c of the first character string 61 is nonuniform. The spacing between mutually-adjacent characters c of the second character string 62 is nonuniform.

As shown in FIG. 14, the setter 21 sets the multiple character candidate regions r for the input image 60. Each of the multiple character candidate regions r includes at least a portion of one character c included in the input image 60.

The calculator 22 sets one of the multiple character candidate regions r as a reference region and calculates the evaluation values relating to the ease of forming links between the reference region and each of the multiple character candidate regions r other than the reference region.

As shown in FIG. 15, the extractor 23 extracts, from the input image 60 based on the evaluation values calculated by the calculator 22, the first character string 61 including a set 71 and a set 72 of the character candidate regions r. Similarly, the extractor 23 extracts the second character string 62 including a set 73 and a set 74. The extractor 23 extracts a third character string 63 including a set 75. The extractor 23 extracts the fourth character string 64 including a set 76.

The corrector 24 modifies the spacing between two mutually-adjacent character candidate regions (characters) for the first character string 61 and the second character string 62. For example, the spacing between the two character candidate regions is modified to become small when the spacing between the two character candidate regions is larger than the reference spacing. The spacing between the two character candidate regions may be modified to become large when the spacing between the two character candidate regions is smaller than the reference spacing.

Specifically, for example, the average value of the spacing between the mutually-adjacent character candidate regions is determined for the first to fourth character strings 61 to 64; and the average value is used as the reference spacing. The maximum value of the spacing between the mutually-adjacent character candidate regions may be determined for the first to fourth character strings 61 to 64; and the maximum value may be used as the reference spacing. That is, the character spacing of the first character string 61 is modified to approach the reference spacing when the character spacing is larger than the reference spacing. The character spacing of the first character string 61 may be modified to approach the reference spacing when the character spacing is smaller than the reference spacing. For example, all of the character spacing of the first character string 61 may be modified to become the reference spacing. Similarly, the character spacing of the second character string 62 may be modified. The degree of the modification may be appropriately adjusted by the settings of the user. Thereby, multiple character spacing 65 of FIG. 13 are modified respectively to multiple character spacing 65a of FIG. 16. Similarly, multiple character spacing 66 of FIG. 13 are modified respectively to multiple character spacing 66a of FIG. 16.

Thus, according to the embodiment, the character spacing of the handwritten character string can be modified for each handwritten character string. Therefore, the handwritten characters can be arranged for easier viewing as handwritten characters even for the image in which the handwritten character strings are multiply mixed.

### Third Embodiment

In the embodiment, the character size of the characters is modified for each handwritten character string. In other words, processing of modifying the size of the character c (a fourth operation) is implemented when the size of the character c is larger than a reference size.

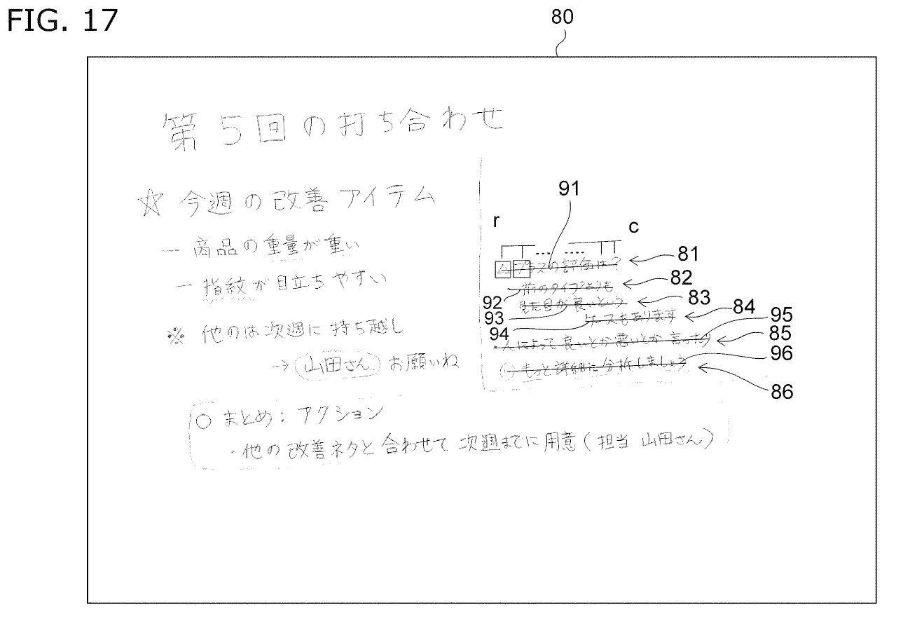

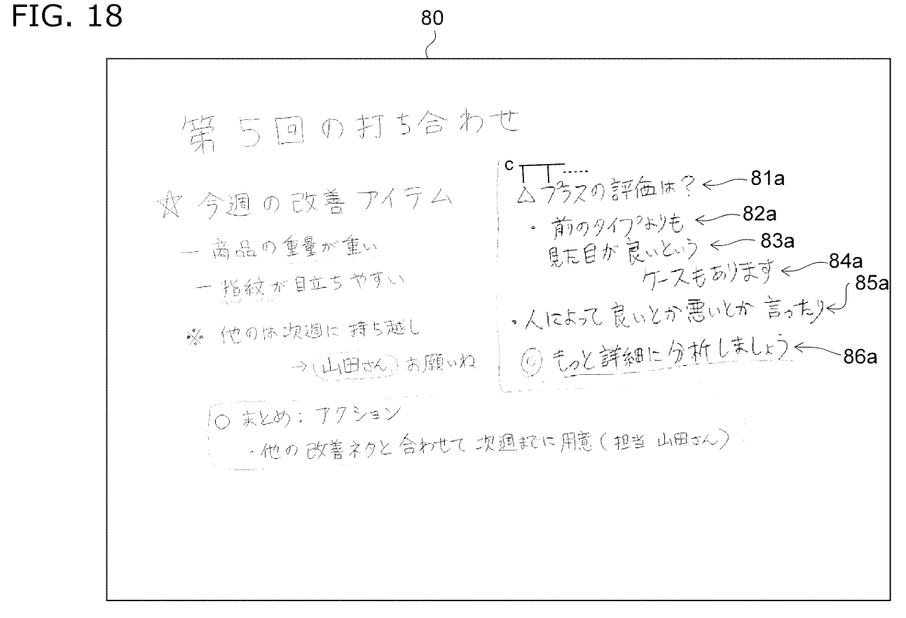

FIG. 17 and FIG. 18 are schematic views showing the input image according to the third embodiment.

FIG. 17 is a schematic view showing the input image prior to the size modification.

FIG. 18 is a schematic view showing the input image after the size modification.

The acquisitor 10 acquires an input image 80 as shown in FIG. 17. The input image 80 includes first to sixth character strings 81 to 86. Each of the first to sixth character strings 81 to 86 includes multiple handwritten characters c.

The setter 21 sets the multiple character candidate regions r for the input image 80. Each of the multiple character candidate regions r includes at least a portion of one character c included in the input image 80.

The calculator 22 sets one of the multiple character candidate regions r as a reference region and calculates the evaluation values relating to the ease of forming links between the reference region and each of the multiple character candidate regions r other than the reference region.

The extractor 23 extracts, from the input image 80 based on the evaluation values calculated by the calculator 22, the first character string 81 including a set 91 of the character candidate regions r. Similarly, the extractor 23 extracts the second character string 82 including a set 92. The extractor 23 extracts the third character string 83 including a set 93. The extractor 23 extracts the fourth character string 84 including a set 94. The extractor 23 extracts the fifth character string 85 including a set 95. The extractor 23 extracts the sixth character string 86 including a set 96.

The corrector 24 modifies the size of the character candidate region r (the character c) included in each of the first to sixth character strings 81 to 86. For example, the size of the character candidate region r is modified to become small when the size of the character candidate region r is larger than the reference size. The size of the character candidate region r may be modified to become large when the size of the character candidate region r is smaller than the reference size.

Specifically, for example, the average value of the sizes of the character candidate regions r of the first to sixth character strings 81 to 86 is determined; and the average value is used as the reference size. The maximum value of the sizes of the character candidate regions r of the first to sixth character strings 81 to 86 may be determined; and the maximum value may be used as the reference size. That is, the character size of each of the first to sixth character strings 81 to 86 is modified to approach the reference size when the character size is larger than the reference size. The character size of each of the first to sixth character strings 81 to 86 may be modified to approach the reference size when the character size is smaller than the reference size. For example, all of the character sizes included in the first to sixth character strings 81 to 86 may be modified to be the reference size. The degree of the modification may be appropriately adjusted by using the settings of the user. Thereby, the character sizes of the first to sixth character strings 81 to 86 of FIG. 17 are modified respectively to the character sizes of first to sixth character strings 81a to 86a of FIG. 18.

Thus, according to the embodiment, the character sizes of the characters included in the handwritten character string can be modified for each handwritten character string. Therefore, the handwritten characters can be arranged for easier viewing as handwritten characters even for the image in which the handwritten character strings are multiply mixed.

### Fourth Embodiment

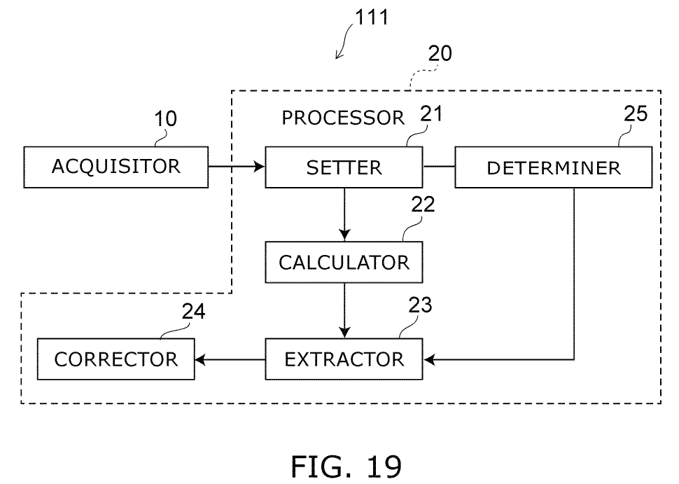

FIG. 19 is a block diagram showing an image processor according to a fourth embodiment.

An image processor 111 of the embodiment includes the acquisitor 10 and the processor 20. The processor 20 includes the setter 21, the calculator 22, the extractor 23, and the corrector 24 and further includes a determiner 25.

The determiner 25 implements determination processing. The determination processing determines whether or not the first character string further includes a noncharacter (also called a noncharacter symbol).

The extractor 23 excludes, from the multiple character candidate regions r, the noncharacter regions determined to be noncharacters.

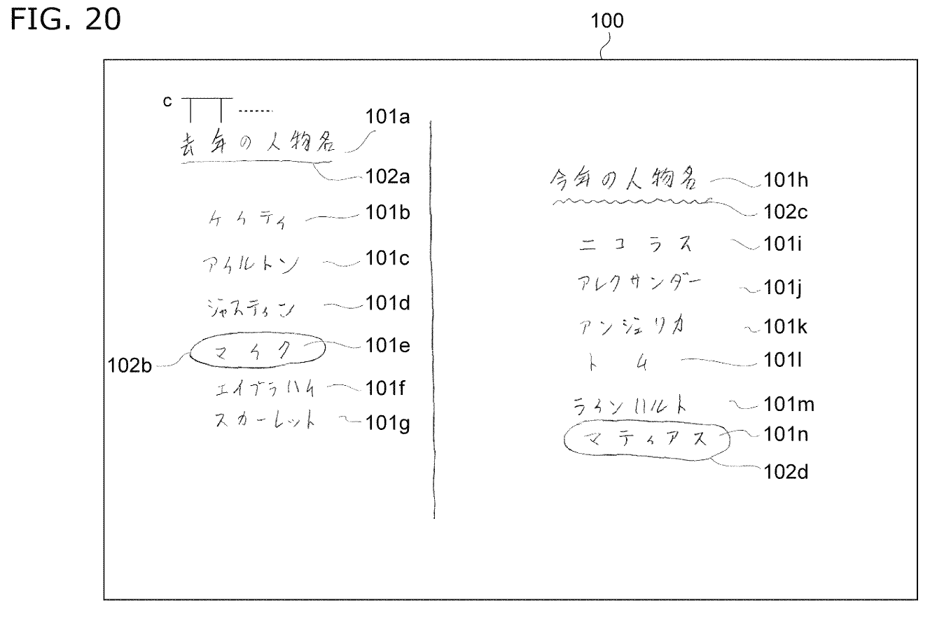

FIG. 20 is a schematic view showing the input image according to the fourth embodiment.

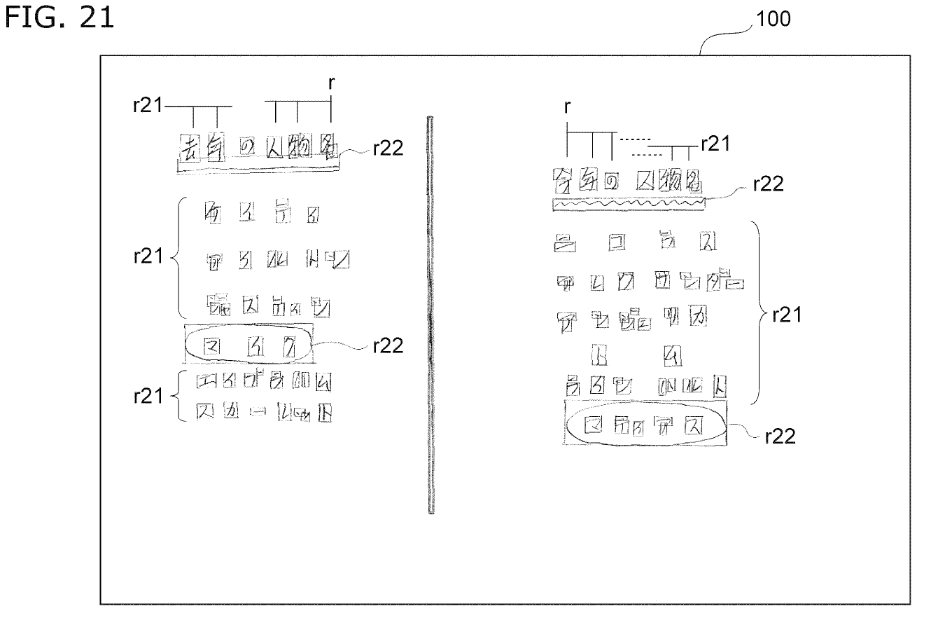

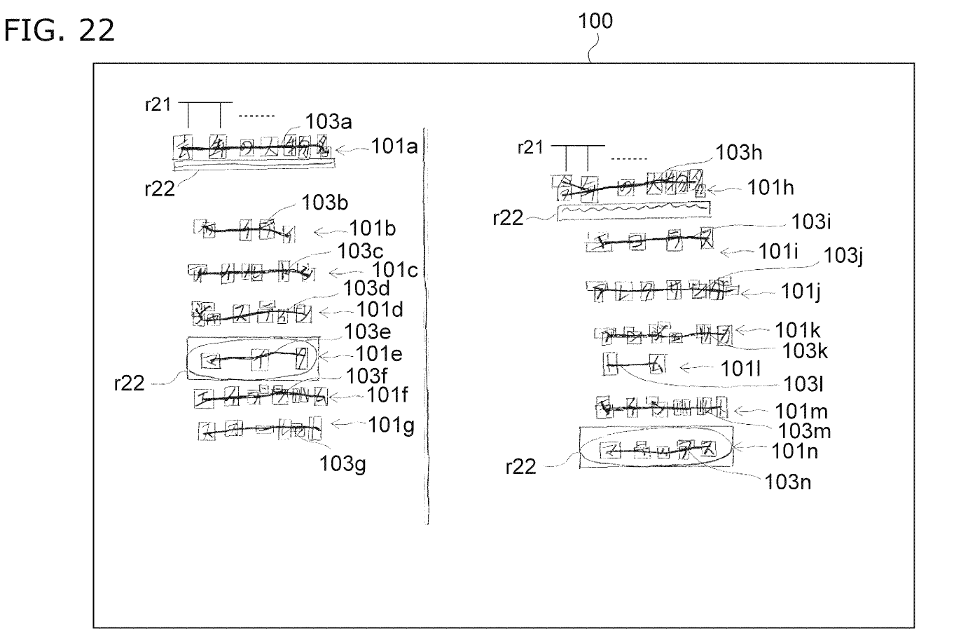

FIG. 21 and FIG. 22 are schematic views showing the image processing method according to the fourth embodiment.

FIG. 21 is a schematic view showing the determination result determined by the determiner 25.

FIG. 22 is a schematic view showing the extraction result extracted by the extractor 23.

The acquisitor 10 acquires an input image 100. As shown in FIG. 20, the input image 100 includes a first character string 101a and a second character string 101b. The input image 100 includes the third to fourteenth character strings 101c to 101n. The input image 100 includes noncharacters 102a to 102d. For example, the noncharacters 102a to 102d are underlines, enclosing lines, etc.

The embodiment focuses on a feature of the noncharacters 102a to 102d including the underlines, the enclosing lines, etc., being different from that of a character, where the feature is the aspect ratio, size, or the like of the configuration of the character candidate region r, the density of the writing pixels for the character candidate region r, etc. For example, there is a method for constructing an identifier using identities such as the configuration of the character candidate region r, the density of the writing pixels, or the like as the feature. A linear SVM (Support Vector Machine) or the like may be considered as a specific example of the identifier.

As shown in FIG. 21, the determiner 25 determines whether or not each of the multiple character candidate regions r is one of a character or a noncharacter. A character region r21 shows the character candidate regions r determined to be characters. A noncharacter region r22 shows the character candidate regions r determined to be noncharacters.

As shown in FIG. 22, the extractor 23 excludes the noncharacter region r22 determined to be a noncharacter by the determiner 25 from the multiple character candidate regions r. The extractor 23 excludes the noncharacter region r22 and extracts the first character string 101a including a set 103a of the character candidate regions r from the remaining multiple character regions r21. Similarly, the second to fourteenth character strings 101b to 101n are extracted.

Thus, according to the embodiment, it can be determined whether or not each of the multiple character strings includes a noncharacter; and the noncharacters can be excluded from each of the multiple character strings. Therefore, the detection precision of the characters can be increased.

### Fifth Embodiment

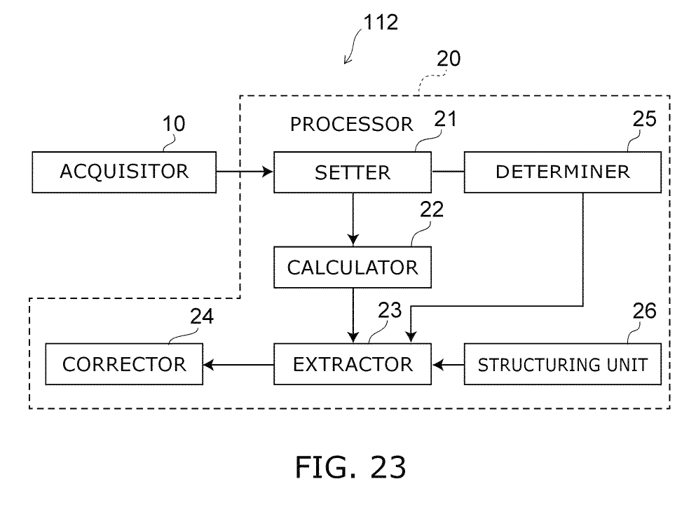

FIG. 23 is a block diagram showing an image processor according to a fifth embodiment.

An image processor 112 of the embodiment includes the acquisitor 10 and the processor 20. The processor 20 includes the setter 21, the calculator 22, the extractor 23, the corrector 24, and the determiner 25 and further includes a structuring unit 26.

The structuring unit 26 implements structuring processing. The structuring processing utilizes the determination result of the determiner 25. In the structuring processing, the first extracted image is extracted by recognizing the noncharacters inside the first character string and removing the noncharacters from the first character string.

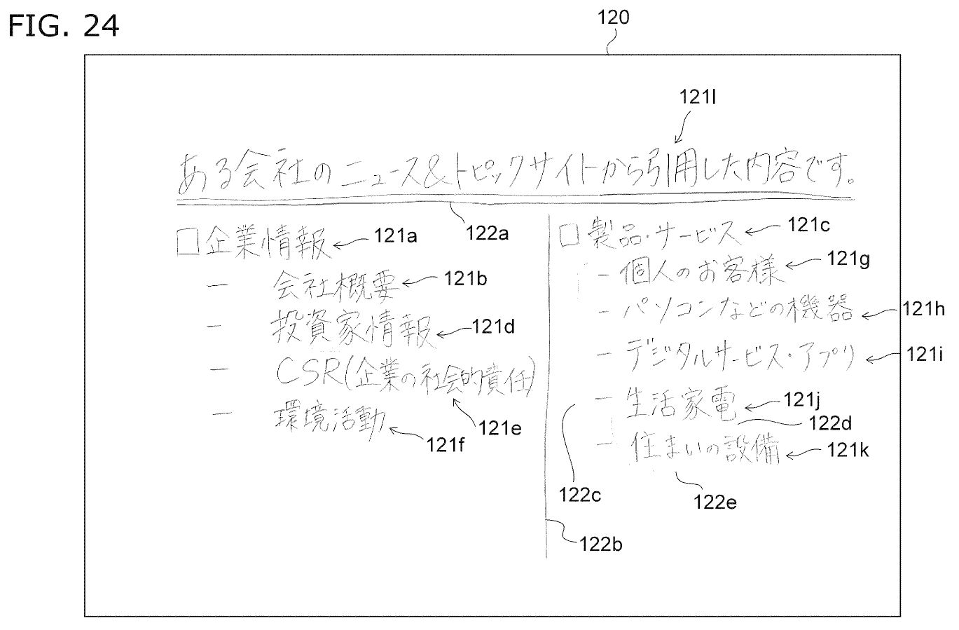

FIG. 24 is a schematic view showing an input image according to the fifth embodiment.

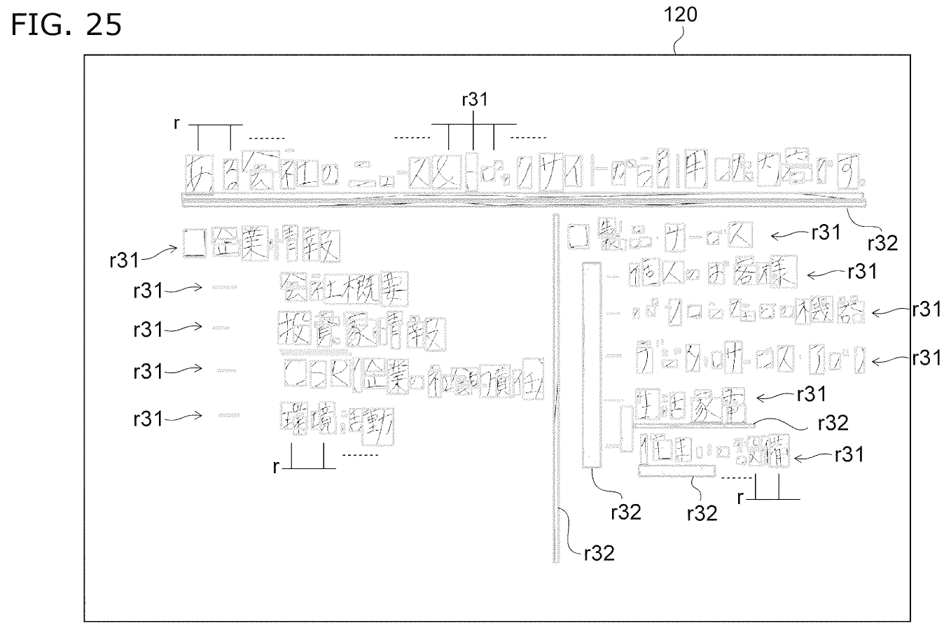

FIG. 25 to FIG. 28 are schematic views showing an image processing method according to the fifth embodiment.

FIG. 25 is a schematic view showing the determination result determined by the determiner 25.

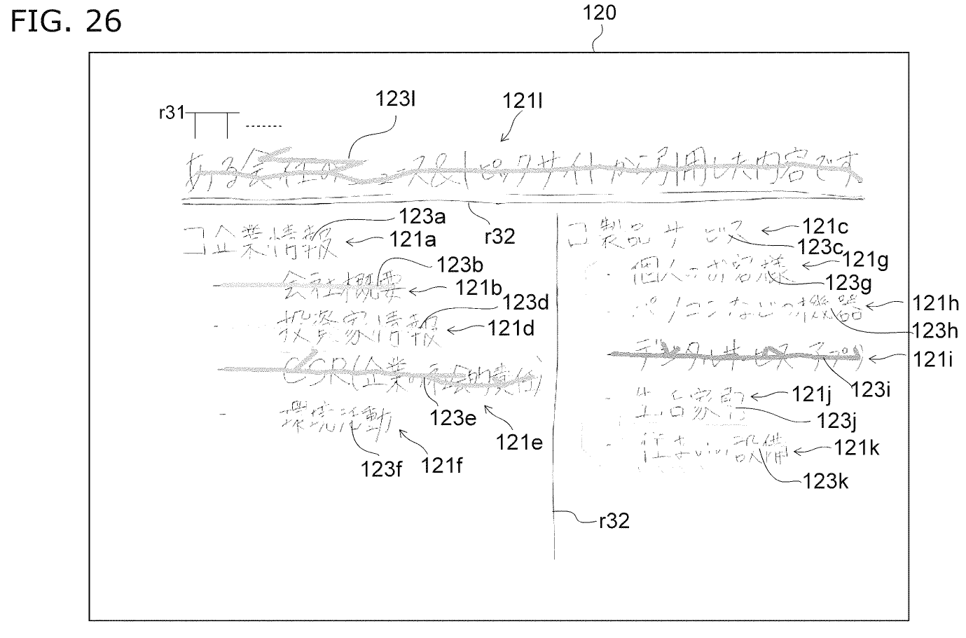

FIG. 26 is a schematic view showing the extraction result extracted by the extractor 23.

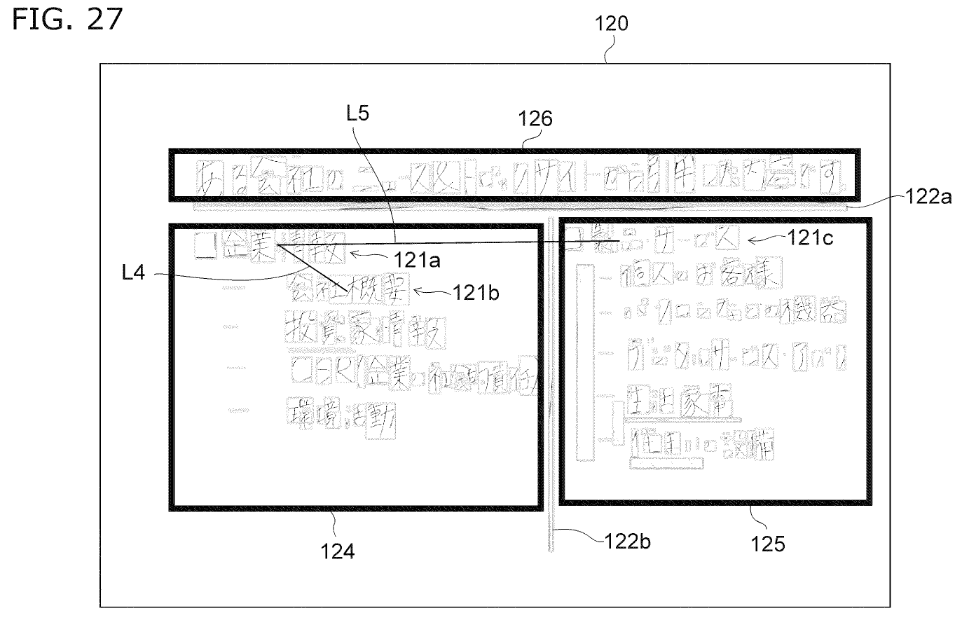

FIG. 27 is a schematic view showing the integration result integrated by the structuring unit 26.

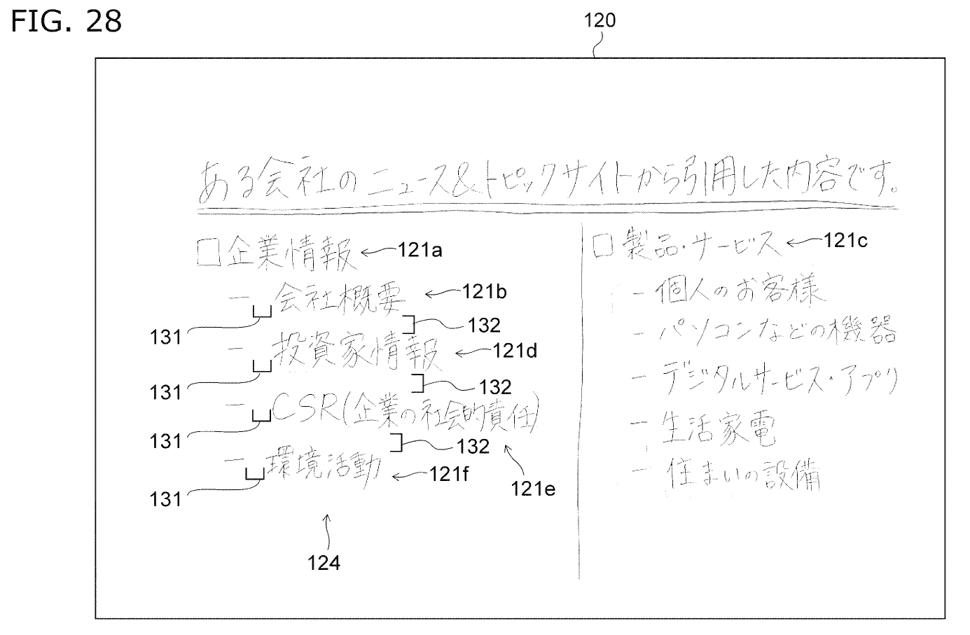

FIG. 28 is a schematic view showing the modification result modified by the corrector 24.

The acquisitor 10 acquires the input image 120. As shown in FIG. 24, the input image 120 includes a first character string 121a, a second character string 121b, and a third character string 121c. The input image 120 further includes fourth to twelfth character strings 121d to 121l. The input image 120 includes noncharacter symbols 122a to 122d. For example, the noncharacter symbols 122a to 122d are underlines, partitioning lines, etc.

Similarly to the fourth embodiment, the embodiment focuses on a feature of the noncharacter symbols 122a to 122d including the underlines, the partitioning lines, etc., being different from that of a character, where the feature is the aspect ratio, size, or the like of the configuration of the character candidate region r, the density of the writing pixels for the character candidate region r, etc. For example, a method for constructing the identifier may be used in which identities such as the configuration of the character candidate region r, the density of the writing pixels, or the like is used as the feature. A linear SVM or the like may be considered as a specific example of the identifier.

As shown in FIG. 25, the determiner 25 determines whether or not each of the multiple character candidate regions r is one of a character or a noncharacter. A character region r31 shows the character candidate regions r determined to be characters. A noncharacter region r32 shows the character candidate regions r determined to be noncharacters.

As shown in FIG. 26, the extractor 23 excludes the noncharacter region r32 determined to be a noncharacter by the determiner 25 from the multiple character candidate regions r. The extractor 23 excludes the noncharacter region r32 and extracts the first character string 121a (the first extracted image) including a set 123a of the character candidate regions r from the remaining multiple character region r31. Similarly, the second character string 121b (the second extracted image) that includes a set 123b of the character candidate regions r is extracted; and the third character string 121c (the third extracted image) that includes a set 123c of the character candidate regions r is extracted. Similarly, the fourth to twelfth character strings 121d to 121l that respectively include sets 123d to 123l of the character candidate regions r are extracted.

As shown in FIG. 27, a line segment L4 (a first line segment) that connects the first character string 121a and the second character string 121b intersects a line segment L5 (a second line segment) that connects the first character string 121a and the third character string 121c; and a noncharacter symbol 122b is provided between the first character string 121a and the third character string 121c. In such a case, the structuring unit 26 integrates the first character string 121a and the second character string 121b. For example, the first character string 121a and the second character string 121b are integrated in one character string group (image group) 124. In the example, three groups (the first character string group 124, a second character string group 125, and a third character string group 126) are integrated by the noncharacter symbols 122a and 122b.

As shown in FIG. 28, the corrector 24 implements modification processing using the character string groups integrated by the structuring unit 26 as the unit of the modification. For example, in the first character string group 124, positions 131 in the lateral direction of the beginning of the lines of the second character string 121b and the fourth to sixth character strings 121d to 121f are modified to be aligned. The second character string 121b and the fourth to sixth character strings 121d to 121f are modified so that row spacing 132 in the vertical direction is uniform.

Thus, according to the embodiment, by utilizing the noncharacter symbols such as the partitioning lines, etc., the multiple handwritten character strings are integrated into one character string group; and the spatial arrangement such as the beginning of the lines, the row spacing, etc., of the multiple handwritten character strings can be modified by the unit of character string group. Thereby, it is possible to arrange the handwritten characters for easy viewing with the merits of being handwritten remaining as-is. By utilizing the partitioning lines, etc., mistaken integration of the multiple handwritten character strings can be suppressed.

### Sixth Embodiment

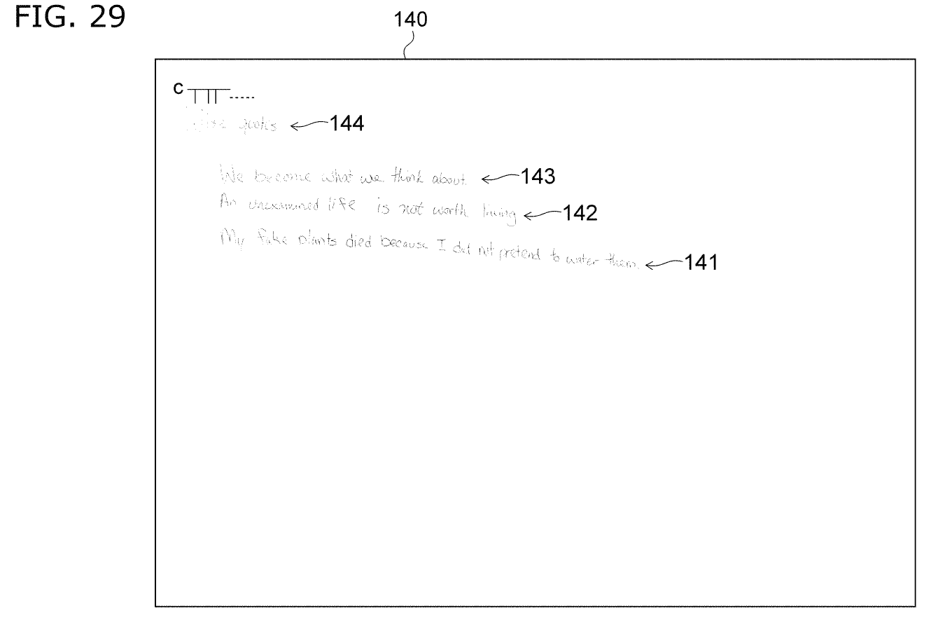

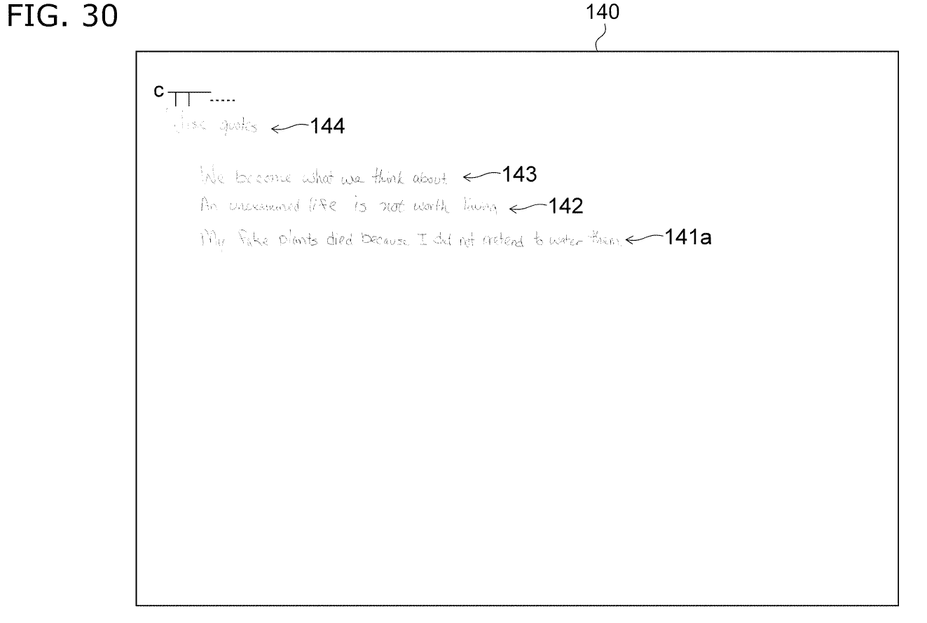

FIG. 29 and FIG. 30 are schematic views showing an input image according to a sixth embodiment.

FIG. 29 is a schematic view showing the input image prior to the tilt modification.

FIG. 30 is a schematic view showing the input image after the tilt modification.

The first to fifth embodiments are described as being used for kanji, hiragana, and katakana of Japanese. The embodiment may be used for the English alphabet.

As shown in FIG. 29, the acquisitor 10 acquires an input image 140. The input image 140 includes first to fourth character strings 141 to 144. Each of the first to fourth character strings 141 to 144 includes multiple handwritten characters c. For example, these characters c are alphabet characters.

As shown in FIG. 30, the processor 20 modifies the tilt of the first character string 141. In the example, the first character string 141 is modified to a first character string 141a. The tilt of the first character string 141a is modified so that the first character string 141a after the tilt modification is substantially parallel to a second character string 142. The modification method is the same as the method described in the first embodiment. Here, a repetitious description is omitted.

Thus, the embodiment is applicable not only to kanji, hiragana, and katakana of Japanese but also the English alphabet and all sorts of languages other than Japanese and English.

### Seventh Embodiment

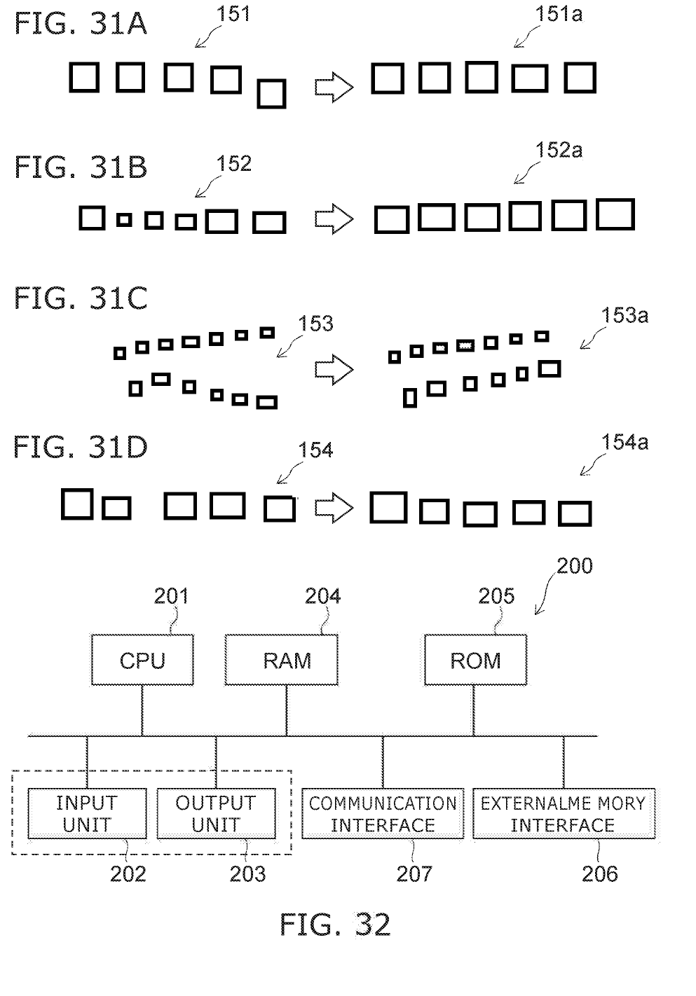

FIG. 31A, FIG. 31B, FIG. 31C, and FIG.31D are schematic views showing arrangement patterns according to a seventh embodiment.

FIG. 31A shows a first arrangement pattern 151 prior to the modification and a first arrangement pattern 151a after the modification.

FIG. 31B shows a second arrangement pattern 152 prior to the modification and a second arrangement pattern 152a after the modification.

FIG. 31C shows a third arrangement pattern 153 prior to the modification and a third arrangement pattern 153a after the modification.

FIG. 31D shows a fourth arrangement pattern 154 prior to the modification and a fourth arrangement pattern 154a after the modification.

As shown in FIG. 31A, in the case where the arrangement of the multiple character candidate regions r included in one handwritten character string is the first arrangement pattern 151, the modification is performed so that the change of the tilt of the handwritten character string of the first arrangement pattern 151a becomes small.

Similarly, as shown in FIG. 31B, in the case where the arrangement of the multiple character candidate regions r included in one handwritten character string is the second arrangement pattern 152, the modification is performed so that the sizes of the character candidate regions included in the handwritten character string of the second arrangement pattern 152a approach each other.

As shown in FIG. 31C, in the case where the arrangement of the multiple character candidate regions r included in two handwritten character strings is the third arrangement pattern 153, the modification is performed so that the tilts of the two handwritten character strings of the third arrangement pattern 153a approach each other.

As shown in FIG. 31D, in the case where the arrangement of the multiple character candidate regions r included in one handwritten character string is the fourth arrangement pattern 154, the modification is performed so that the spacing of the character candidate regions included in the handwritten character string of the fourth arrangement pattern 154a approach each other.

### Eighth Embodiment

FIG. 32 is a block diagram showing an image processor according to an eighth embodiment.

An image processor 200 of the embodiment is realizable by various devices such as a desktop or laptop general-purpose computer, a portable general-purpose computer, other portable information devices, an information device that includes an imaging device, a smartphone, other information processors, etc.

As shown in FIG. 32, as a configuration example of hardware, the image processor 200 of the embodiment includes a CPU 201, an input unit 202, an output unit 203, RAM 204, ROM 205, an external memory interface 206, and a communication interface 207.

It is possible to execute the instructions of the processing methods of the embodiment described above based on a program which is software. It is also possible to obtain effects similar to the effects of the image processor of the embodiment described above by the general-purpose computer system pre-storing the program and reading the program. The instructions described in the embodiment described above are recorded, as a program that can cause the execution by a computer, in a magnetic disk (a flexible disk, a hard disk, etc.), an optical disk (CD-ROM, CD-R, CD-RW, DVD-ROM, DVD±R, DVD±RW, etc.), semiconductor memory, or similar recording media. The storage format of the recording medium may have any form as long as the recording medium is readable by a computer or embedded system. The computer can realize an operation similar to that of the image processor of the embodiment described above based on the program by reading the program from the recording medium and executing the instructions recited in the program using the CPU. Of course, the computer may perform the acquiring or reading via a network when acquiring or reading the program.

Database management software or the OS (operating system) operating on the computer, MW (middleware) operating on a network, etc., may execute a portion of the processing for realizing the embodiment based on the instructions of the program installed in the computer or the embedded system from the recording medium.

The recording medium of the embodiment is not limited to a recording medium that is independent of the computer or the embedded system; and the recording medium of the embodiment also includes a recording medium that stores or temporarily stores a downloaded program transmitted by a LAN, the Internet, etc. The recording medium is not limited to one type; and the recording medium of the embodiment also includes the case where the processing of the embodiment is executed from multiple recording media. The configuration of the recording medium may be any configuration.

The computer or the embedded system of the embodiment executes the processing of the embodiment based on the program stored in the recording medium and may have any configuration such as a device made of one of a personal computer, a microcomputer, or the like, a system in which multiple devices are connected by a network, etc.

The computer of the embodiment is not limited to a personal computer, also includes a processor included in an information processing device, a microcomputer, etc., and generally refers to devices and apparatuses that can realize the functions of the embodiment by using a program.

According to the embodiments, an image processor, an image processing method, and an image processing program can be provided in which handwritten characters can be arranged for easy viewing.

Hereinabove, embodiments of the invention are described with reference to specific examples. However, the invention is not limited to these specific examples. For example, one skilled in the art may similarly practice the invention by appropriately selecting specific configurations of components such as the acquisitor, the processor, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all image processors, image processing methods and non-transitory recording mediums practicable by an appropriate design modification by one skilled in the art based on the image processors, image processing methods and non-transitory recording mediums described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processor, comprising:
an acquisitor acquiring an input image including a first character string; and
a processor implementing a first operation of generating a first generated image from a first extracted image based on an arranged state of the first character string, the first extracted image being extracted from the input image, relating to the first character string, and extending in a first direction, the first generated image extending in a second direction different from the first direction.

2. The device according to claim 1, wherein
the input image further includes a second character string, and
the absolute value of an angle between the first direction and a third direction of a second extracted image is greater than the absolute value of an angle between the second direction and the third direction, the second extracted image being extracted from the input image, relating to the second character string, and extending in the third direction.

3. The device according to claim 1, wherein
the input image further includes a second character string, and
the processor generates a second generated image from a second extracted image, the second extracted image being extracted from the input image, relating to the second character string, and extending in a third direction, the second generated image extending in a fourth direction different from the third direction.

4. The device according to claim 3, wherein the fourth direction is the same as the second direction.

5. The device according to claim 1, wherein
the input image further includes a second character string and a third character string,
a first line segment intersects a second line segment, the first line segment connecting the first extracted image to a second extracted image, the second line segment connecting the first extracted image to a third extracted image, the second extracted image being extracted from the input image and relating to the second character string, the third extracted image being extracted from the input image and relating to the third character string,
the processor integrating the first extracted image and the second extracted image when a noncharacter symbol is provided between the first extracted image and the third extracted image.

6. The device according to claim 1, wherein
the processor sets a first rectangular region around the first image, and
the first operation includes generating the first generated image from the first extracted image by modifying a first tilt of the first rectangular region with respect to a set direction determined inside the input image.

7. The device according to claim 1, wherein
the processor sets a first rectangular region around the first image, and
the first operation includes generating the first generated image from the first extracted image by modifying a first tilt of the first rectangular region with respect to a set direction determined inside the input image when the first tilt is larger than a first reference tilt.

8. The device according to claim 1, wherein
the first character string includes a first character and a second character, and
the processor implements a second operation of modifying a second tilt with respect to the first direction of a line segment connecting the first character to the second character when the second tilt is larger than a second reference tilt.

9. The device according to claim 1, wherein
the first character string includes a first character and a second character, and
the processor implements a third operation of modifying a spacing between the first character and the second character when the spacing is larger than a reference spacing.

10. The device according to claim 1, wherein
the first character string includes a first character, and
the processor implements a fourth operation of modifying a size of the first character when the size is larger than a reference size.

11. The device according to claim 1, wherein the processor extracts the first extracted image by recognizing a noncharacter inside the first character string and removing the noncharacter from the first character string.

12. The device according to claim 1, wherein a character included in the first character string is a handwritten character.

13. An image processing method, comprising:
acquiring an input image including a first character string; and
generating a first generated image from a first extracted image based on an arranged state of the first character string, the first extracted image being extracted from the input image, relating to the first character string, and extending in a first direction, the first generated image extending in a second direction different from the first direction.

14. The method according to claim 13, wherein
the input image further includes a second character string, and
the absolute value of an angle between the first direction and a third direction of a second extracted image is greater than the absolute value of an angle between the second direction and the third direction, the second extracted image being extracted from the input image, relating to the second character string, and extending in the third direction.

15. The method according to claim 13, wherein
the input image further includes a second character string, and
the processor generates a second generated image from a second extracted image, the second extracted image being extracted from the input image, relating to the second character string, and extending in a third direction, the second generated image extending in a fourth direction different from the third direction.

16. The method according to claim 15, wherein the fourth direction is the same as the second direction.

17. The method according to claim 13, wherein
the input image further includes a second character string and a third character string,
a first line segment intersects a second line segment, the first line segment connecting the first extracted image to a second extracted image, the second line segment connecting the first extracted image to a third extracted image, the second extracted image being extracted from the input image and relating to the second character string, the third extracted image being extracted from the input image and relating to the third character string, and
the method comprises integrating the first extracted image and the second extracted image when a noncharacter symbol is provided between the first extracted image and the third extracted image.

18. A non-transitory recording medium having an image processing program being recorded in the recording medium, the image processing program causing a computer to execute:
acquiring an input image including a first character string; and
generating a first generated image from a first extracted image based on an arranged state of the first character string, the first extracted image being extracted from the input image, relating to the first character string, and extending in a first direction, the first generated image extending in a second direction different from the first direction.
